(19) United States
(12) Patent Application Publication
(10) Pub. No.: US 2002/0069199 A1
(43) Pub. Date: Jun. 6, 2002

(54) Method for managing alarm information in a network management system

(76) Inventor: Young-Hyun Kang, Seoul (KR)

Correspondence Address: Robert E. Bushnell, 1522 K Street, N.W., Suite 300, Washington, DC, 20005-1202, US

(21) Appl. No.: 09/834,901

(22) Filed: Apr. 16, 2001

(30) Foreign Application Priority Data
Dec. 1, 2000 (KR) 2000-72603

(51) Int. Cl. G06F 7/00

(52) U.S. Cl. 707/9

(57) ABSTRACT

A method for managing alarm information in a network management system, comprises the steps of receiving alarm information generated from any of a plurality of network elements, locating the network elements generating the alarm information, determining whether or not the alarm information is a logical alarm, searching database to determine whether the same logical alarm as the received logical alarm is already stored therein, storing the alarm information in the database if not already stored therein, and increasing a count value representing the number of times at which the same alarm information has occurred without storing the alarm information into the database and storing the increased count value in the database at a position corresponding to the stored alarm information.

### CLAIM OF PRIORITY

This application makes reference to, incorporates the same herein, and claims all benefits accruing under 35 U.S.C §119 from an application entitled Method For Managing Alarm Information In NMS earlier filed in the Korean Industrial Property Office on Dec. 1, 2000, and there duly assigned Serial No. 72603/2000 by that Office.

### BACKGROUND OF THE INVENTION

1. Field of the Invention

The present invention relates to a network management system for managing a plurality of network elements (a.k.a.: nodes or subscribers) and more particularly to a method for optimizing a database which stores alarm information generated from the network elements.

2. Description of the Related Art

Conventionally, a network management system operates, manages, and maintains a communications network consisting of a number of network elements such as a transmission system, an exchange system, a router, etc., by collecting their state information, which is required to enable an operator to control the communications network. When the network element encounters a problem, undergoes a state change, or is subjected to structural change so as to influence the communication services, the network management system generates alarm information accordingly, which is stored into a database. By this, the network manager maintains or repairs the network element generating the alarm information.

Examples of such systems are found in the following U.S. patents, incorporated by reference: U.S. Pat. No. 5,949,759 to Andre Cretegny et al. entitled Fault Correlation System And Method In Packet Switching Networks; U.S. Pat. No. 6,124,790 to Maxim A. Golov et al. entitled System And Method For filtering An Alarm; U.S. Pat. No. 5,799,317 to Jingsha He et al. entitled Data Management System For A Telecommunications Signaling System 7 (SS#7); and U.S. Pat. No. 5,388,198 to Ching Y. Kung entitled Alarm Filter In An Expert System For Communications Network.

Generally, the processing of the alarm information in a network management system having an alarm daemon processor, utilizes a network management system that stands by to receive the alarm information generated from network elements connected with the network. The network management system temporarily stores the alarm information into an alarm manager buffer to enable the system to locate the network elements generating the alarm information, since the database storing the alarm information of the network management system consists of tables to distinguish the network elements.

The network management system delivers the alarm information to a database application interface (DBAPI) to convert it into a data format of the database to be stored into the tables corresponding to the network elements, so that the operator may search the database to retrieve desired alarm information. Namely, when the operator asks the network management system to retrieve the desired alarm information, it provides a display screen to enable the operator to search out the alarm information by entering predetermined search parameters corresponding to the alarm information.

The network management system stores the alarm information generated from each network element into the database without distinguishing whether it corresponds to logical or physical information.

Finally, the network management system displays the alarm information searched out from the database according to the search parameters. Accordingly, the screen displaying errors according to the requested alarm information may only display the alarm information representing, for example, the location of the ports having generated the alarms and their sequence.

More specifically, in the processing of the alarms, they are simply classified according to predetermined parameters, and sequentially stored according to the alarm date and time, without noticing whether the alarm is, for example, a logical alarm such as a loss of link, poor quality of signal, etc. Hence, the amount of alarm information displayed on the screen is so large that it is hard for the operator to analyze and retrieve the contents of the alarm.

Moreover, since the conventional network management system repeatedly stores the same alarm information generated from the same network element into the database without noticing its redundancy, the storage space of a hard disk for storing the database is unnecessarily filled, and the recurrences of the same alarm information both make it impossible to correctly locate a network element generating it and increases the searching time.

### SUMMARY OF THE INVENTION

It is an object of the present invention to provide a method for effectively managing the alarm information received from the network elements to optimize the database in the network management system.

According to an aspect of the present invention, a method for managing alarm information, in a network management system, comprises the steps of receiving alarm information generated from a plurality of network elements, identifying the network element generating the alarm information, determining whether or not the alarm information is a logical alarm, searching a database to detect whether the same logical alarm as the received logical alarm is already stored in the database, storing the alarm information in the database if not already stored therein, increasing a count value representing the number of times at which the same alarm information has occurred, and storing the increased count value in the database at a position corresponding to the stored alarm information without redundantly storing the alarm information into the database.

### BRIEF DESCRIPTION OF THE ATTACHED DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is an exemplary flow chart for illustrating the steps of processing alarm information in a network management system;

FIG. 2 is an example of a screen displaying the alarm information processed according to the flow chart of FIG. 1;

FIG. 3 is a schematic diagram for illustrating a preferred embodiment of the structure of network management system according to the present invention;

FIG. 4 is a flow chart for illustrating the steps of operating each element of a network management system according to the present invention;

FIG. 5 is a flow chart for illustrating the steps of processing the alarm information in a network management system according to the present invention;

FIG. 6 illustrates the structure of the alarm data format received from each network element of the network management system according to the present invention;

FIG. 7 is the structure of the data format of subscriber connection information corresponding to the location value of the alarm according to the present invention; and

FIG. 8 is an example of a screen displaying the alarm information in the network management system according to the present invention.

### DETAILED DESCRIPTION OF THE PREFERRED EMBODIMENT

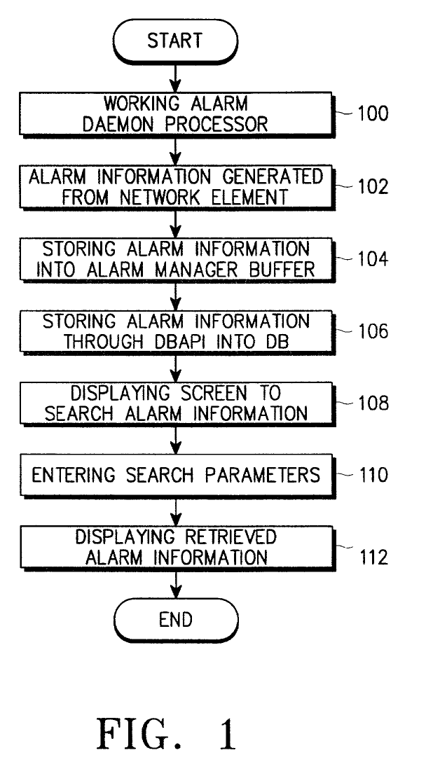

Referring to FIG. 1 for illustrating the steps of processing alarm information in an example of a network management system, wherein an alarm daemon processor is operated to process the alarm information in step 100 as long as there is power applied to the system. In step 102, the network management system stands by to receive any alarm information generated from the network elements connected with the network. The network management system temporarily stores the alarm information into an alarm manager buffer in step 104 to identify the network element generating the alarm information, since the database storing the alarm information of the network management system consists of tables to distinguish the network elements.

In step 106, the network management system delivers the alarm information to a database application interface (DBAPI) to convert it into the data format of the database stored into the tables corresponding to the network elements, so that the operator may search the database to retrieve desired alarm information. Namely, when the operator searches the network management system to retrieve desired alarm information, it provides a display screen to enable the operator to search out the alarm information, in step 108, such that the operator enters predetermined search parameters for locating the alarm information. Finally, the network management system displays the alarm information retrieved from the database according to the search parameters, in step 112.

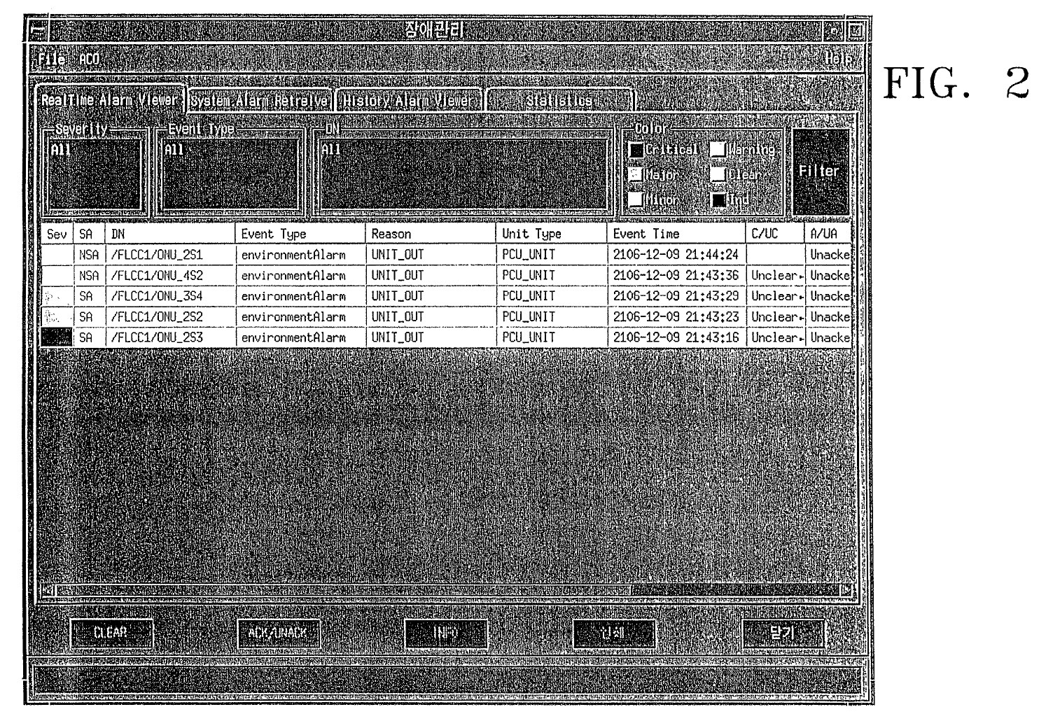

Referring to FIG. 2, a screen displays errors according to the alarm information requested, the network management system stores the alarm information generated from each network element into the database without distinguishing whether it corresponds to logical information or physical information, and therefore the screen may only display the alarm information representing the location of the network elements, or ports, having generated the alarms and their sequence.

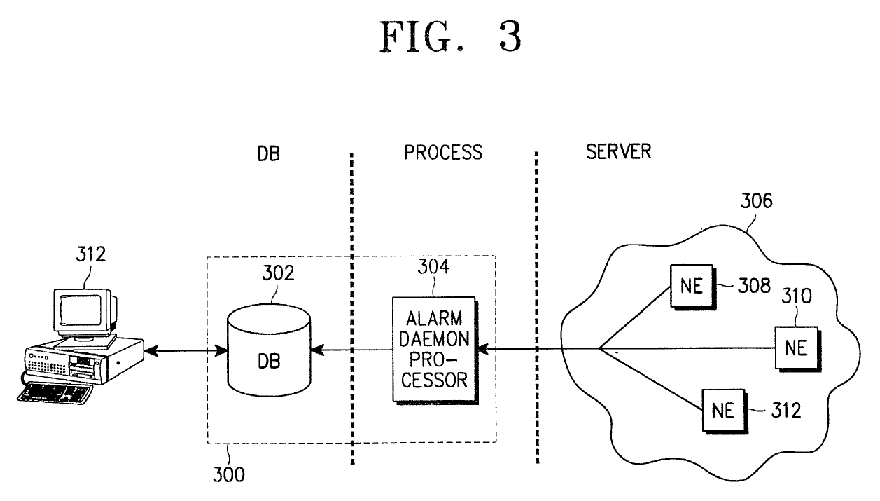

Referring to FIG. 3, a network management system 300, according to a preferred embodiment of the present invention, manages and maintains a plurality of network elements 308, 310, and 312 through a server 306 via a communications network. The network management system, while turned on, works the alarm daemon processor 304 to monitor the network elements to detect alarm information generated by errors occurring within the network elements, which is written into tables, corresponding to the network elements having generated the errors, of a database 302 for the operator 312 to be informed of alarm information.

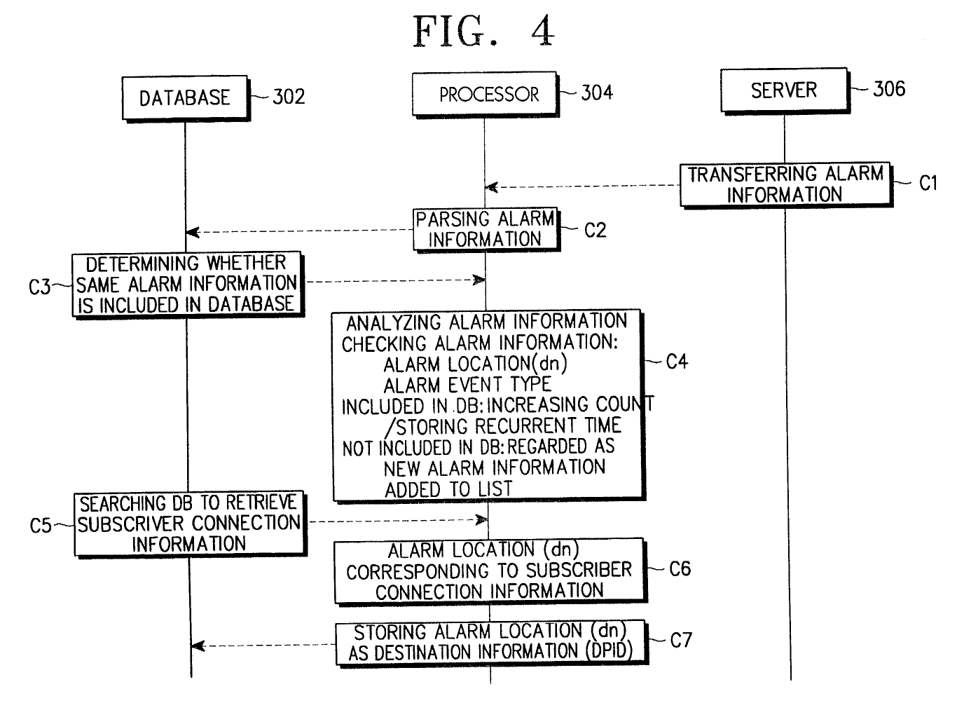

Describing the steps of processing the alarm information in connection with FIGS. 3 and 4, the server 306 connecting the plurality of network elements 308, 310 and 312, via a communications network, transfers alarm information to the alarm daemon processor 304 of the network management system 300 in step Cl. If the alarm information corresponds to a physical error, the alarm daemon processor 304 parses it, in step C2, to be directly stored in the database 302.

If the alarm information corresponds to a logical error, the alarm daemon processor 304 searches the database 302 to determine, in step C3, whether the alarm information is already stored the database 302. Then, if the alarm information has been already stored in the database 302 by checking, in step C4, the location (dn), i.e., identifying the network element generating the alarm information, and the event type of the alarm, its recurrent count is increased, and its recurrent time is stored in the database.

If the alarm information has not already been stored in the database 302, it is regarded as new alarm information and added, in step C4, to the alarm information list.

Instep C5 the alarm daemon processor 304 searches the database 302 to retrieve subscriber connection information, then the alarm location (dn)corresponding to the retrieved subscriber connection information is obtained in step C6 in order to store, in step C7, the alarm location as destination information (DPID) in database 302.

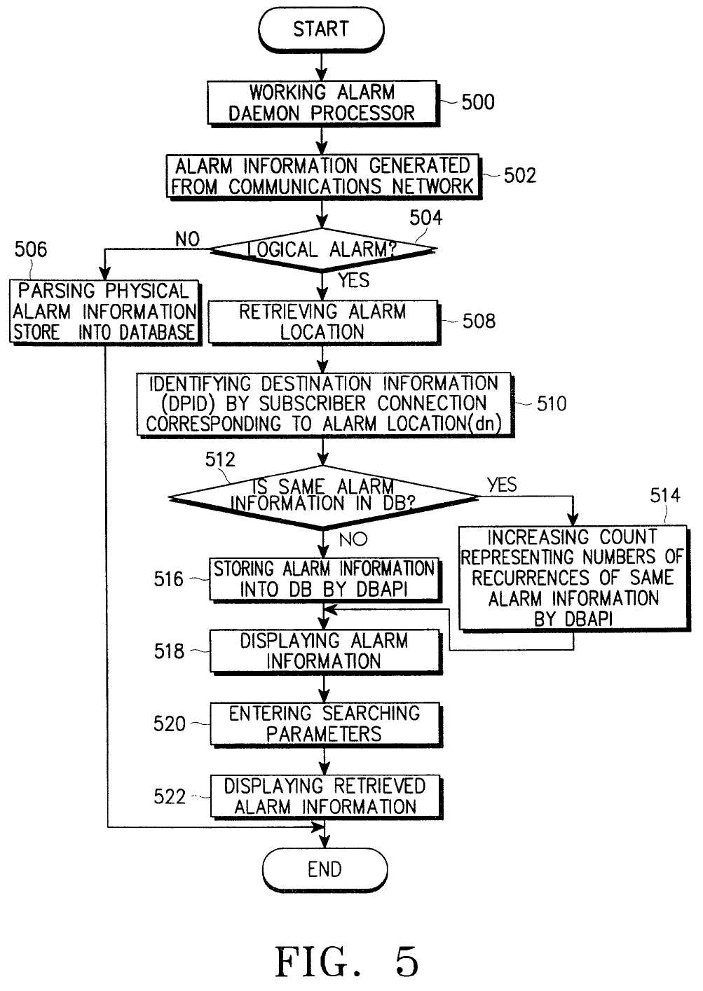

Describing in detail the process of managing the alarm information in the network management system in connection with FIGS. 3 and 5, the network management system 300, while turned on, works the alarm daemon processor 304 in step 500. Then, the alarm daemon processor 304 of network management system 300 receives any the alarm information generated from network elements 308, 310, 312 connected via the communications network of server 306, in step 502.

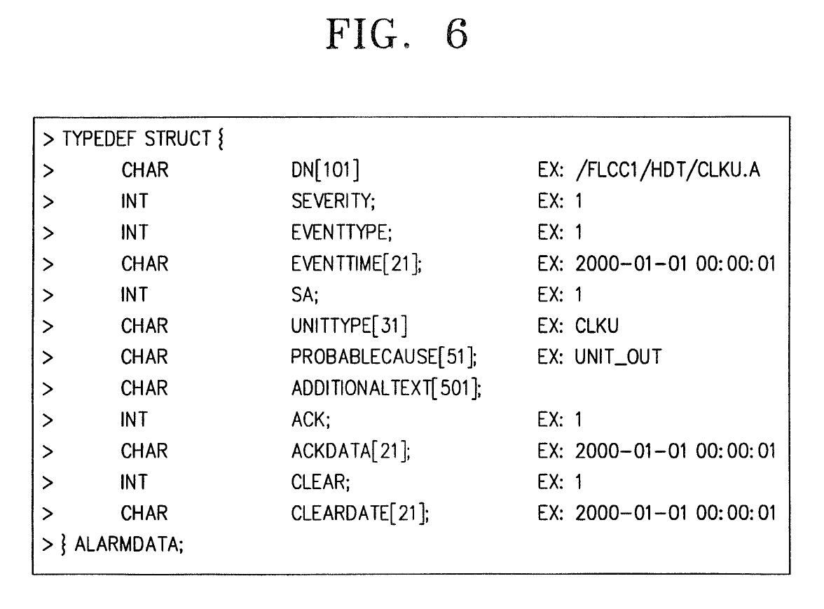

The alarm information transferred from the network element to the alarm daemon processor 304 has the data format as shown in FIG. 6, comprising location (dn), event type, severity, probable cause, additional text, event time, etc.

Accordingly, the network management system 300 analyzes the alarm data format to determine at step 504 whether the nature of the alarm corresponds to a logical error or a physical error. If the alarm generated from a certain network element is determined to correspond to a physical error, like loss of signal (LOS), alarm indication signal (AIS), loss of frame (LOF), loss of pointer (LOP), etc., rather than a logical alarm like loss of link (LOS), poor quality of signal (QOS), etc., the network management system proceeds to step 506 to simply parse the data format of the received alarm information for storage into the database 302.

Alternatively, if the alarm is determined to correspond to a logical error, the network management system 300 proceeds to step 508 to retrieve the alarm location (dn). Then, it proceeds to step 510 to identify the destination information (DPID) by the VPI/NVCI (virtual path identifier/ virtual channel identifier) of the subscriber connection information corresponding to the alarm location (dn). This step is needed because the database 302 storing the alarm information comprises tables distinguishing respective network elements, or subscribers, as previously described.

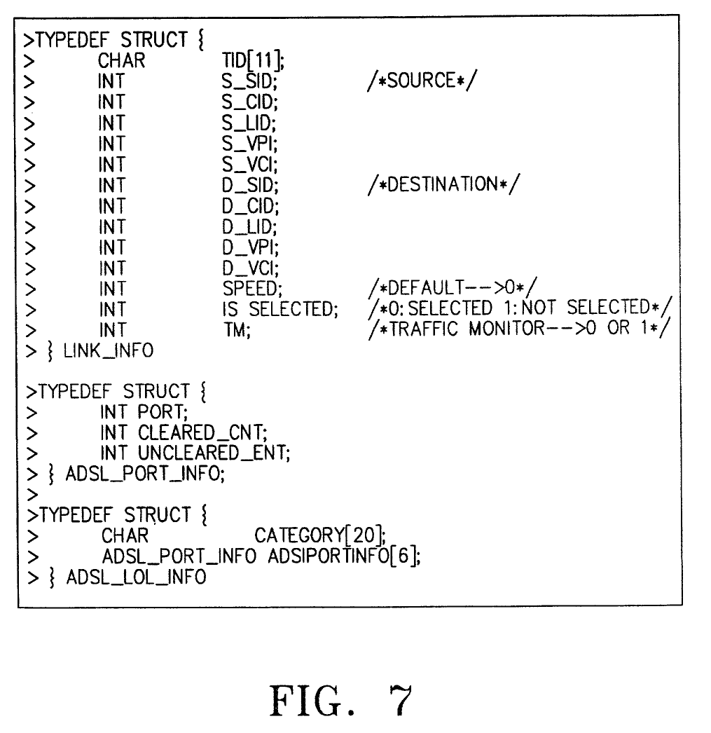

FIG. 7 shows the alarm statistics data format distinguishing subscribers to identify the destination information (DPID) by the subscriber connection information corresponding to the alarm location (dn).

Then, the network management system 300 searches, at step 512, the database 302 to determine if it already includes the same information, i.e., as the present alarm information. That is, at step 512, the alarm information is analyzed to detect a positional value, event type and the destination information by the VPI/NvCI of the subscriber connection information corresponding to the alarm location (dn) to determine whether the alarm information corresponds to alarm information already received and stored in database 302. This is to avoid storing, into the database 302, redundant logical alarm information recurring at the same subscriber location, thus both economizing the storage capacity of the database and simplifying a searching process.

Hence, if the same alarm information has already been stored in the database 302, the network management system 300 proceeds to step 514 to increase the count representing the number of recurrences of the same alarm instead of repeatedly storing the alarm information into the database 302.

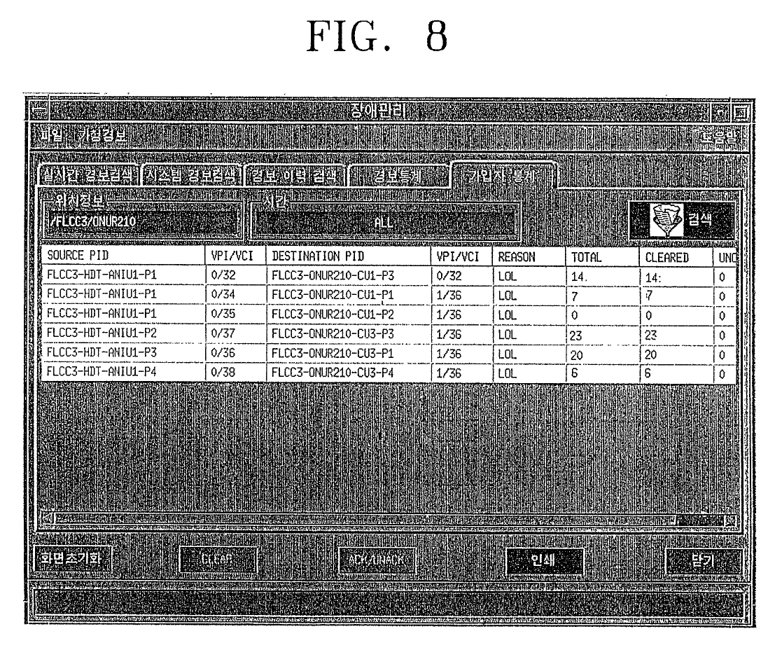

FIG. 8 shows a screen displaying the alarm information when storing the increased count representing the number of recurrences of the same alarm into the database 302. The alarm information table additionally includes the subscriber statistics item recording the number of recurrences of the logical alarm so as both to economize the storage capacity of the database 302 and to simplify the searching process, compared to the table as shown in FIG. 2.

Alternatively, if the alarm information has not been stored in the database 302, the network management system 300 proceeds to step 516 to convert the present alarm information through a database application interface (DBAPI: not shown) into the database data format to be recorded as new alarm information in the alarm table of the corresponding network element.

When the operator begins to search the database 302 from a computer system 312, the network management system 300 enables the screen displaying the alarm information, in step 518, as shown in FIG. 8. Then, if the user enters the search parameters for the alarm information required in step 520, the network management system 300 proceeds to step 522 to retrieve the corresponding alarm information for display. That is, the user enters search parameters for finding a particular error corresponding to the alarm information or for finding a particular network element and its corresponding alarm information, and then only the retrieved alarm information is displayed.

Thus, the inventive method enables the network management system to distinguish the physical and logical alarms generated from network elements, enables the network management system to determine whether the logical alarm information is already stored in the database so that the value corresponding to the number of counted recurrences is stored instead of storing redundant alarm information to reduce the amount storage space used for storing the alarm information thereby optimizing the storage capacity of the database, and to enhance the performance of a search function. In addition, the alarm information statistics of respective subscribers may be obtained to understand their behavioral characteristics.

While the present invention has been described in connection with specific embodiments accompanied by the attached drawings, it will be readily apparent to those skilled in the art that various changes and modifications may be made thereto without departing the gist of the present invention.

What is claimed is:

1. A method for managing alarm information in a network management system, comprising the steps of:
receiving alarm information generated from any of a plurality of network elements;
determining whether or not said alarm information corresponds to a logical alarm;
determining the location of the network element generating the alarm information, when it is determined that the alarm information corresponds to a logical alarm;
searching a database to determine whether said database already has said alarm information stored therein, according to the location of the network element generating the alarm information;
storing said alarm information when it is determined that said database does not have said alarm information already stored therein;
increasing a count value representing a number of times in which the same alarm information has been generated, without redundantly storing said alarm information into said database, when it is determined that said alarm information is already stored in said database; and
storing the increased count value at a position corresponding to said alarm information already stored in said database.

2. The method as set forth in claim 1, wherein the step of searching said database further comprises the steps of:
analyzing said alarm information to detect its positional value and event type; and
determining whether said database has the alarm information of the same positional value and event type.

3. The method as set forth in claim 1, wherein the step of searching said database further comprises the steps of:
detecting the positional value of said alarm information from its data format; and
identifying destination information by analyzing a virtual path identifier and a virtual channel identifier of subscriber connection information corresponding to the alarm location to determine an identity of a subscriber from which said alarm information was generated.

4. The method as set forth in claim 1, further comprising a step of parsing said alarm information for storage into said database when it is determined that the alarm information does not correspond to a logical alarm.

5. The method as set forth in claim 1, wherein said database comprises a plurality of network element tables, each corresponding to a respective one of said network elements, said step of storing further comprising storing said alarm information into the corresponding network element table of said database according to the location of the network element.

6. The method as set forth in claim 5, further comprising a step of converting the alarm information through a database application interface into a database data format of said database to be recorded as new alarm information in the network element table of the network element generating the alarm information.

7. The method as set forth in claim 5, further comprising steps of:
displaying said alarm information stored in said database;
entering search parameters for finding a particular error corresponding to the alarm information or for finding a particular network element and its corresponding alarm information; and
displaying information retrieved as a result of said step of entering search parameters.

8. A method for managing alarm information in a network management system connected to a plurality of subscribers at a plurality of network elements, comprising the steps of:
driving an alarm daemon processor when said network management system is powered on;
receiving, via said alarm daemon processor, alarm information generated from at least one of said network elements;
determining whether said alarm information is due to a logical error or a physical error in the network element generating the received alarm information;
determining the location of the network element generating the alarm information, when it is determined that the alarm information is due to a logical error;
searching a database to determine whether said database already has said alarm information stored therein, according to the location of the network element generating the alarm information;
storing said alarm information when it is determined that said database does not have said alarm information already stored therein;
increasing a count value representing a number of times in which the same alarm information has been generated, without redundantly storing said alarm information into said database, when it is determined that said alarm information is already stored in said database; and
storing the increased count value at a position corresponding to said alarm information already stored in said database.

9. The method as set forth in claim 8, wherein the step of searching said database further comprises the steps of:
analyzing said alarm information to detect its positional value and event type; and
determining whether said database has the alarm information of the same positional value and event type.

10. The method as set forth in claim 8, wherein the step of searching said database further comprises the steps of:
detecting the positional value of said alarm information from its data format; and
identifying destination information by analyzing a virtual path identifier and a virtual channel identifier of subscriber connection information corresponding to the alarm location to determine an identity of a subscriber from which said alarm information was generated.

11. The method as set forth in claim 8, further comprising a step of parsing said alarm information for storage into said database when it is determined that the alarm information is due to a physical error.

12. The method as set forth in claim 8, wherein said database comprises a plurality of network element tables, each corresponding to a respective one of said network elements, said step of storing further comprising storing said alarm information into the corresponding network element table of said database according to the location of the network element.

13. The method as set forth in claim 12, further comprising a step of converting the alarm information through a database application interface into a database data format of said database to be recorded as new alarm information in the network element table of the network element generating the alarm information.

14. The method as set forth in claim 12, further comprising steps of:
displaying said alarm information stored in said database;
entering search parameters for finding a particular error corresponding to the alarm information or for finding a particular network element and its corresponding alarm information; and
displaying information retrieved as a result of said step of entering search parameters.
